(19) United States
(12) Patent Application Publication
(10) Pub. No.: US 2023/0230502 A1
(43) Pub. Date: Jul. 20, 2023

(54) Generation and Use of Coaching Score

(71) Applicant: Speedgauge, Inc., San Francisco, CA (US)

(72) Inventor: Matthew James Moehr, Minneapolis, MN (US)

(21) Appl. No.: 17/577,898

(22) Filed: Jan. 18, 2022

(51) Int. Cl. G09B 19/16; G06N 20/00; G07C 5/08

(52) U.S. Cl. CPC G09B 19/167; G06N 20/00; G07C 5/0841

(57) ABSTRACT

The present disclosure is directed to improving safety of drivers that drive vehicles that belong to a fleet of vehicles. This may include identifying individual drivers that should receive a training or coaching session. Scores that associated vehicle type, vehicle weight class, time of day, number of stops/starts, and other factors could be evaluated to identify drivers that may have been assigned a highest risk factor. Company telematic data as well as public data that identify types of roadways, roadway conditions, experience levels, and other factors may be combined with numbers of accidents or speeding tickets when an analysis is performed. Methods described herein may be implemented according to a machine learning model based on a processor executing instructions out of a memory. This may include deep learning or the neural network technology.

### BACKGROUND OF THE INVENTION

### Field of the Invention

The present disclosure is generally directed to identifying driving risks. More specifically, the present disclosure is directed to identifying a driver that should receive coaching.

### Description of the Related Art

Many risks are associated with the driving of vehicles along different types of roadways. While companies could benefit from conducting coaching or training sessions with each driver that drives vehicles for that company, these companies often do not have the resources to continuously train all of their drivers or even most of their drivers on a regular basis. What are needed are new methods that identify specific drivers that should receive training or coaching at an appropriate time.

### SUMMARY OF THE PRESENTLY CLAIMED INVENTION

The present invention is directed to a method, a non-transitory computer-readable storage media, and an apparatus that perform analysis. In a first embodiment, a method may include receiving vehicle operation data associated with a plurality of vehicles and a plurality of operators. This vehicle operation data may include telematics sensor information associated with each of the plurality of operators operating one or more respective vehicles of the plurality of vehicles. This method may also include receiving incident data associated with a plurality of negative vehicle operation outcomes that each involve a respective vehicle of the plurality of vehicles and a respective operator of the plurality of operators. One or more trained machine learning models may be used to identify a riskiest operator of the plurality of operators at least in part by inputting at least the vehicle operation data and the incident data into the one or more trained machine learning models. This may result in an alert being output that indicates or identifies the riskiest operator.

In a second embodiment, the presently claimed method may be implemented as a non-transitory computer-readable storage media that executes instructions out of the memory to receive vehicle operation data associated with a plurality of vehicles and a plurality of operators. This vehicle operation data may include telematics sensor information associated with each of the plurality of operators operating one or more respective vehicles of the plurality of vehicles. Here again, this method may also include receiving incident data associated with a plurality of negative vehicle operation outcomes that each involve a respective vehicle of the plurality of vehicles and a respective operator of the plurality of operators. One or more trained machine learning models may be used to identify a riskiest operator of the plurality of operators at least in part by inputting at least the vehicle operation data and the incident data into the one or more trained machine learning models. This may result in an alert being output that indicates or identifies the riskiest operator.

In a third embodiment, an apparatus that includes a memory and a processor may implement functions of a machine learning model. The processor when executing instructions of the machine learning model may evaluate received vehicle operation data associated with a plurality of vehicles and a plurality of operators. Here again this vehicle operation data may include telematics sensor information associated with each of the plurality of operators operating one or more respective vehicles of the plurality of vehicles. The processor may also execute instructions out of the memory to evaluate received incident data associated with a plurality of negative vehicle operation outcomes that each involve a respective vehicle of the plurality of vehicles and a respective operator of the plurality of operators and identify a riskiest operator of a plurality of operators based on the vehicle operation data and the incident data being inputs of the machine learning model. Information identifying or indicating the riskiest operator may then be output as a result of the machine learning model.

### BRIEF DESCRIPTION OF THE DRAWINGS

FIG. 1 is a flow diagram illustrating a process that includes a series of operations that may be used to identify a driver that should receive coaching at a particular time.

FIG. 2 is a flow diagram illustrating a process that includes a service of operations that may be used by a trained machine learning model for identifying the riskiest operator.

FIG. 3 is a block diagram illustrating an example of a neural network that can be used by a machine learning engine for identifying at risk drivers

FIG. 4 illustrates an exemplary computing system that may be used to implement methods consistent with the present disclosure.

### DETAILED DESCRIPTION

The present disclosure is directed to significantly improving safety of drivers that drive vehicles that belong to a fleet of vehicles. This may include incrementally identifying individual drivers that should receive a training or coaching session. For example, one or two drivers out of a group of drivers could be identified every week. Scores that associated vehicle type, vehicle weight class, time of day, number of stops/starts, and other factors could be evaluated to identify drivers that may have been assigned a highest risk factor or number. Company telematic data as well as public data that identify types of roadways, roadway conditions, experience levels, and other factors may be combined with numbers of accidents or speeding tickets when an analysis is performed. Methods described herein may be implemented according to a machine learning model based on a processor executing instructions out of a memory. This may include deep learning or application of neural network technology.

Data collected from all over a region or country could be collected, sorted, analyzed, and the be provide to a machine learning (ML) process to identify a driver that should receive training at a moment in time. Processes such as a random forest model may be used in to identify riskiest drivers. In certain instances, data may be evaluated at regular timer intervals (e.g. weekly). An output from a ML process may include a number that ranges from 0 to 100. This number may be referred to as a risk value or risk index that may correspond to a likelihood that a driver has a high probability of experiencing a negative outcome in a second time interval (e.g. on a next trip, in the next 6 weeks, or in the next 6 months). Driving data and analysis may correspond to types of roadways (interstate, highway, city, or other), levels of road congestion, and other factors. Risk factors may be associated with driver data, for example, how frequently a driver speeds or how much does a particular driver drives over the speed limit in a week or month. Other driver details may include number of harsh braking events, frequency of harsh braking events, number or frequency of swerving events, or medial data (eye test data). Driver scores may also be tracked overtime to identify instances when a driver's performance is getting worse over time. Methods of the present disclosure may use of neural networks as part of a learning process or a process that identifies riskiest drivers.

Identifying drivers that could benefit most from a driver training or coaching session at an appropriate time is a concern of the present disclosure. Risks associated with driving may be associated with a type of vehicle, a type of roadway, an amount of traffic or congestion on the roadway, a time of day, or speed limits of a roadway. While in certain instances, a worst driver may benefit from a driver training session, this worst driver may not be a driver that is most at risk of experiencing a negative driving outcome. This may be because the worst driver may be scheduled to drive on an easiest set of roads at a best time of day, where a best driver may be scheduled to drive on more difficult roads. Because of this a driver that is most at risk may be a best driver of a group of drivers. Evaluations may identify that this best driver should be associated with a highest risk based on an evaluation that analyzes roadway types, types of vehicles, times of day, trip durations, or other factors. Such analysis may identify whether these factors correspond to a threshold risk level for a given driver or a highest risk level for the given driver.

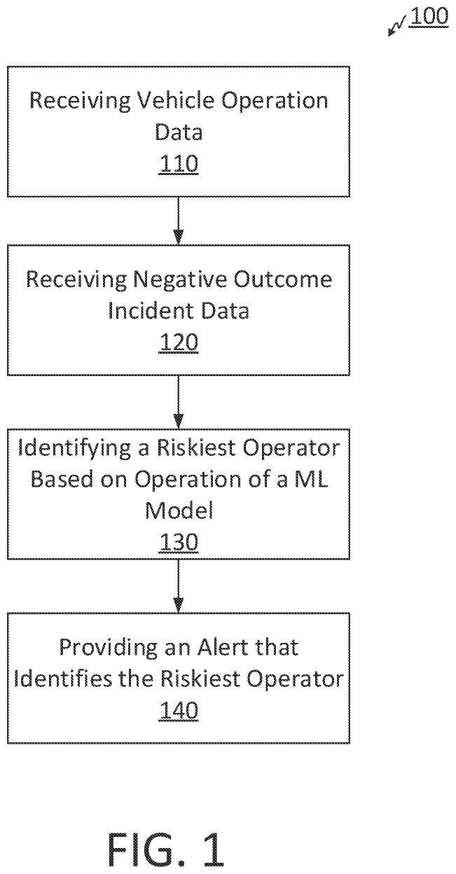

FIG. 1 is a flow diagram illustrating a process 100 that includes a series of operations that may be used to identify a driver that should receive coaching at a particular time. The process 100 of FIG. 1, including the operations 110, 120, 130, and/or 140 of the process, may be performed by a vehicle management system or apparatus. Examples of the vehicle management system that performs the process 100 include the vehicle management system that performs the process 200, the neural network 300, the computing system 400, an apparatus that analyzes operational characteristics of vehicles based on machine learning model(s), a non-transitory computer-readable storage medium having embodied thereon a program executable by a processor for implementing a method for vehicle operation analysis, or a combination thereof.

The process 100 includes operation 110, at which the vehicle management system receives vehicle operation data. The vehicle operation data can be associated with a plurality of vehicles and a plurality of operators (e.g., drivers). The vehicle operation data can include telematics sensor information associated with each of the plurality of operators operating one or more respective vehicles of the plurality of vehicles. The plurality of vehicles can include telematics systems with telematics sensors that capture the telematics sensor information and transceivers that provide the telematics sensor information to the vehicle management system to be received at operation 110. This vehicle operation data may include or be associated with a driving schedule that cross references specific operators (e.g., drivers) with driving days, time of day, trip durations, roadway types, and/or vehicle types.

The process 100 also includes operation 120, at which the vehicle management system receives incident data (e.g., negative vehicle outcome incident data). The incident data may be associated with a plurality of negative vehicle operation outcomes (or incidents) that each involve at least one respective vehicle of the plurality of vehicles and a respective operator of the plurality of operators. A plurality of negative vehicle operation outcomes include, for example, instances of speeding, instances of harsh braking, instances of swerving, instances of red light violations, instances of parking violations, instances of vehicular accidents (e.g., collisions), instances of reckless driving, instances of driving while impaired, or combinations thereof. In some examples, the vehicle management system receives at least some of the incident data from the telematics systems of the plurality of vehicles, as captured by the telematics sensors. In some examples, the vehicle management system receives at least some of the incident data from data sources of traffic information (e.g., identifying crashes, speeding tickets, parking tickets, tolls, red light violations, and the like). This negative vehicle outcome incident data may include data that identifies speeding tickets, accidents, and/or other information regarding different types of roadways.

The process 100 also includes operation 130, at which the vehicle management system identifies a riskiest operator based on operation of one or more trained machine learning (ML) models. For instance, the vehicle management system can use the one or more trained ML models to identify a risky operator (e.g., riskiest operator) of the plurality of operators at least in part by inputting at least the vehicle operation data and the incident data into the one or more trained ML models. Examples of the one or more trained ML models include one or more trained random forests (RFs), one or more trained support vector machines (SVMs), one or more trained neural networks (NNs) (e.g., neural network 300), one or more deep networks, one or more convolutional neural networks (CNNs), one or more autoencoders, one or more time delay neural networks (TDNNs), one or more deep belief nets (DBNs), one or more recurrent neural networks (RNNs), one or more generative adversarial networks (GANs), or combinations thereof.

In some examples, the one or more trained ML models may be trained (e.g., by the vehicle management system and/or another computing system 400) using supervised learning using training data, unsupervised learning using training data, or a combination thereof. The training data can include vehicle operation data, incident data, and pre-determined risk evaluations for different operators based on the vehicle operation data and the incident data.

In some examples, the one or more ML models output a number, which in some cases falls within a range from 0 to 100. This number may be referred to as a risk number, risk value, risk metric, or risk index that may correspond to a likelihood that a driver has a high probability of experiencing a negative outcome in a second time interval (e.g. on a next trip, in the next 6 weeks, or in the next 6 months). This may result in a driver with a highest risk number of a group of drivers being assigned to a training or coaching session. Operation 130 may also include identifying a type of risky behavior that the riskiest operator exhibits, and/or a type of behavior for which to provide training or coaching about to the riskiest operator, such as training or coaching regarding driving in snow, driving at night, driving on highways, driving in the city, staying within a safe distance of other cars, avoiding speeding, avoiding harsh braking, avoiding swerving, avoiding accidents, avoiding other negative behavior, or a combination thereof.

In some examples, the vehicle management system using the one or more trained ML models to identify the riskiest operator, as in operation 130, includes using the one or more trained ML models to rank the plurality of operators by level of risk. For instance, in response to input of the vehicle operation data and the incident data, the one or more trained ML models can output numeric levels of risk for each of the plurality of operators. To identify the riskiest operator as in operation 130, the vehicle management system can select the operator with the highest level of risk from the ranking, for instance by sorting the operators by level of risk.

In some examples, using the one or more trained machine learning models to identify the riskiest operator includes using the one or more trained machine learning models to identify one or more predicted negative vehicle operation outcomes associated with the riskiest operator. In some examples, in response to input of the vehicle operation data and the incident data, the one or more trained ML models can output predicted negative vehicle operation outcome(s) (e.g., predicted incidents of speeding, vehicle accidents, and the like) for different operators and/or vehicles. In some examples, in response to input of the vehicle operation data and the incident data, the one or more trained ML models can output predicted a respective probability of one or more negative vehicle operation outcome(s) for different operators and/or vehicles. In some examples, to identify the riskiest operator as in operation 130, the vehicle management system can select the operator with the highest amount of, and/or severity of, predicted negative vehicle operation outcomes, for instance by sorting the operators by amount and/or severity of predicted negative vehicle operation outcomes. In some examples, to identify the riskiest operator as in operation 130, the vehicle management system can select the operator with the highest probability of, and/or severity of, predicted negative vehicle operation outcomes, for instance by sorting the operators by probability and/or severity of predicted negative vehicle operation outcomes.

In some examples, the vehicle management system and/or the one or more trained ML models can control for covariates. For instance, in some examples, identification of one or more predicted negative outcomes based on vehicle operation data while taking into account potential differences in context and thoroughfare attributes, wherein the thoroughfare attributes include road type classifications, In some examples, the context attributes include posted speed limits, average traffic flow speed, and time of day. In some examples, this can allow the vehicle management system and/or the one or more trained ML models to accurately compare two operators, even if those two drivers are on different types of roads (e.g., highway vs. city), to identify the riskiest operator.

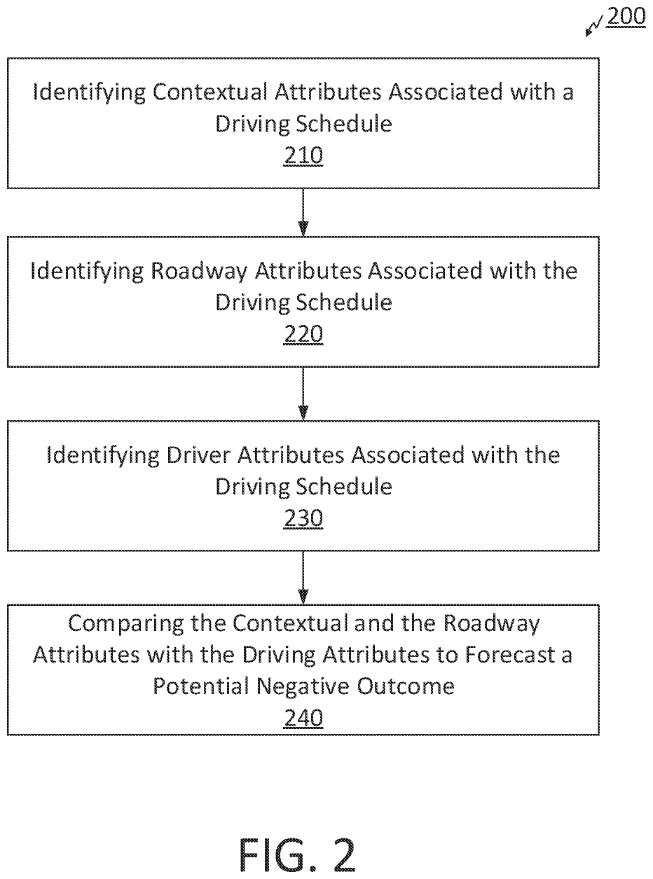

In some examples, to identify the riskiest operator, the vehicle management system and/or the one or more trained ML models perform at least a subset of the process 200 of FIG. 2.

The process 100 also includes operation 140, at which the vehicle management system outputs and/or provides an alert that indicates and/or identifies the riskiest operator. After the riskiest operator is identified in operation 130, the alert of operation 140 can identify the riskiest operator, for instance such that the riskiest operation can be assigned to a training or coaching session. In some examples, outputting and/or providing the alert includes sending (transmitting) (e.g., over a network) the alert (e.g., as an email, text message, or another message) to a recipient device associated with a supervisor, the operator (e.g., the riskiest operator), a fleet manager, an administrator, law enforcement, an insurance entity, or a combination thereof. In some examples, outputting and/or providing the alert includes displaying the alert on a display, such as the display system 470. In some examples, outputting and/or providing the alert includes playing audio associated with the alert through an audio output device (e.g., loudspeaker(s), headphone(s)). In some examples, outputting the alert includes automatically assigning the riskiest operator to a coaching session, for instance using a calendar application, a schedule application, an appointment application, one or more data structures (e.g., databases) associated therewith, or a combination thereof.

In some examples, the vehicle management system receives feedback regarding the riskiest operator, for example from a user interface (e.g., input devices 460) and/or sent (e.g., over a network) from a feedback device. For instance, the feedback device can be a computing device 400 associated with

updating the one or more trained machine learning models by using the feedback as additional training data.

In an instance when vehicle operational data indicates that experienced drivers who drive at night on a trip that takes more than a predetermined time period (e.g., six hours) (i.e. a first set of vehicle operational data) are more likely to be issued a traffic citation or experience an accident (i.e. a negative outcome) than a novice driver that drives for less than the predetermined time period (e.g., three hours) during the day (a second set of operational data), the experienced driver may be identified as being the riskiest driver based on a comparison that compares vehicle operational data, negative outcome data with driver data and driver schedule data.

FIG. 2 is a flow diagram illustrating a process 200 that includes a series of operations that may be used by a trained machine learning model for identifying a riskiest operator. The process 200 of FIG. 2, including the operations 210, 220, 230, and/or 240 of the process, may be performed by a vehicle management system or apparatus. Examples of the vehicle management system that performs the process 200 include the vehicle management system that performs the process 100, the neural network 300, the computing system 400, an apparatus that analyzes operational characteristics of vehicles based on machine learning model(s), a non-transitory computer-readable storage medium having embodied thereon a program executable by a processor for implementing a method for vehicle operation analysis, or a combination thereof.

The process 200 includes operation 210, at which the vehicle management system identifies contextual attributes associated with a driving schedule. These contextual attributes may include a speed limit, a level of traffic flow or congestion of a roadway, a time of day, weather conditions, and/or combinations thereof. The process 200 includes operation 220, at which the vehicle management system identifies roadway attributes associated with the driving schedule are identified. These roadway attributes may include a type of roadway and/or information regarding how contextual attributes may affect roadway conditions.

The process 200 includes operator 230, at which the vehicle management system identifies driver attributes may be. These driver attributes may include an experience level, a number of tickets or accidents (negative outcomes) have been associated with specific drivers, and/or types of roads or type of roadway conditions that particular drivers have limited experience with. A driver that is considered to be an experienced driver yet has not driven in snowy or icy conditions recently (e.g. within the last two years) may be classified as a riskiest driver.

The process 200 includes operation 240, at which the vehicle management system compares the driver attributes with contextual attributes (e.g., a time of day, a season of the year) and with roadway attributes (e.g., mountain road, precipitation level (e.g. rain or snow)) to forecast one or more potential negative outcomes or predicted negative outcomes. The vehicle management system can perform the operations 210, 220, and 230 in any order. In some examples, the vehicle management system performs at least two of the operations 210, 220, and 230 at least partially in parallel.

In an instance when a driver is going to drive on a mountain roadway after changing weather conditions that included falling snow followed by melting conditions during the day that in turn is followed by cold nighttime conditions could be used to identify compared to driver scheduling data indicating that an experience driver is scheduled to drive in such changing weather conditions. This identification may be used to assign a risk value to this experienced driver that is higher than risk values assigned to other drivers because of the challenging driving conditions associated with snow and icy conditions. In other words, an experienced driver that is scheduled to drive in certain conditions (over the mountains at a time where snow may fall or when changing weather conditions correspond to a particular type of risk) may be assigned a highest risk factor based on those challenging conditions. Such a comparison may result in a relatively experienced driver being identified as a riskiest driver of a plurality of drivers that work for a particular company. Risk factors associated with particular driving conditions may also be increased for drivers that have not driven in a specific set of challenging road conditions over a time period. For example, a first driver with more years of driving experience may be assigned a higher risk factor for driving in icy conditions than a second driver based on the second driver having more hours of driving in icy conditions than the first driver in the last two years.

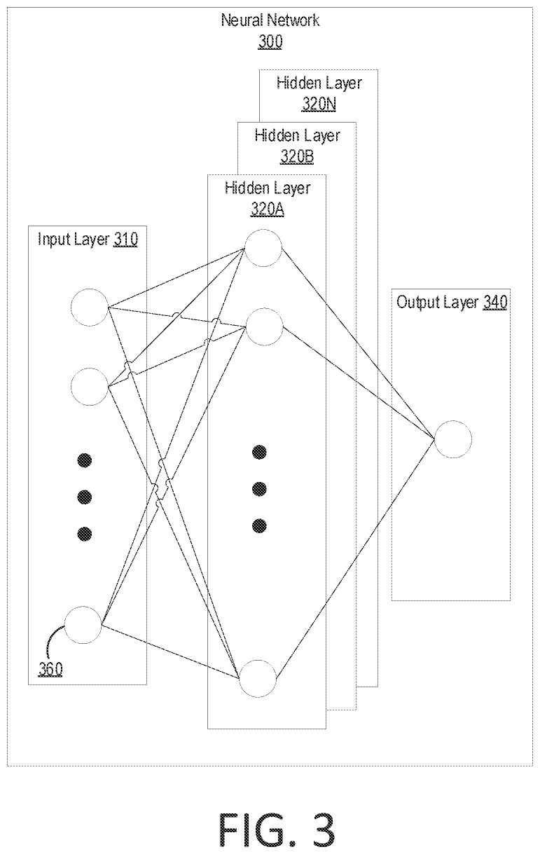

FIG. 3 is a block diagram illustrating an example of a neural network that can be used by a machine learning engine for identifying at risk drivers. Examples of the machine learning engine and/or the neural network (NN) 300 of FIG. 3. Such a neural network 300 can include any type of deep network, such as a convolutional neural network (CNN), an autoencoder, a deep belief net (DBN), a recurrent neural network (RNN), a generative adversarial network (GAN), and/or other type of neural network. The machine learning engine can include, for example, one or more NN(s) 300, CNN(s), TDNN(s), deep network(s), autoencoder(s), DBN(s), RNN(s), GAN(s), trained support vector machine(s) (SVM(s)), trained random forests (RF(s)), or combinations thereof. The neural network 300 can be an example of the one or more machine learning models of the process 100 of FIG. 1.

An input layer 310 of the neural network 300 includes input data. The input data of the input layer 310 can include data representing, for example, the vehicle operation data and/or the incident data discussed in respect to the process 100 of FIG. 1. The input data of the input layer 310 can include data representing, for example, contextual attribute data, roadway attribute data, and/or driver attribute data discussed in respect to the process 200 of FIG. 2.

The neural network 300 includes multiple hidden layers 320A, 320B, through 320N. The hidden layers 320A, 320B, through 320N include “N” number of hidden layers, where “N” is an integer greater than or equal to one. The number of hidden layers can be made to include as many layers as needed for the given application. The neural network 300 further includes an output layer 340 that provides an output resulting from the processing performed by the hidden layers 320A, 320B, through 320N.

In some examples, the output layer 340 can provide an output that includes the risk number associated with an operator as discussed with respect to FIG. 1, the probability of one or more predicted negative vehicle operation outcome(s) (e.g., incidents) associated with an operator as discussed with respect to FIG. 1, the amount of predicted negative vehicle operation outcome(s) (e.g., incidents) associated with an operator as discussed with respect to FIG. 1, the severity of predicted negative vehicle operation outcome(s) (e.g., incidents) associated with an operator as discussed with respect to FIG. 1, a ranking of the operators as discussed with respect to FIG. 1, an identification of a riskiest operator as discussed with respect to FIG. 1, the probability of one or more potential negative outcomes associated with an operator as discussed with respect to FIG. 2, the predicted negative outcomes discussed with respect to FIG. 2, or a combination thereof.

The neural network 300 is a multi-layer neural network of interconnected filters. Each filter can be trained to learn a feature representative of the input data. Information associated with the filters is shared among the different layers and each layer retains information as information is processed. In some cases, the neural network 300 can include a feed-forward network, in which case there are no feedback connections where outputs of the network are fed back into itself. In some cases, the network 300 can include a recurrent neural network, which can have loops that allow information to be carried across nodes while reading in input.

In some instances, information can be exchanged between the layers through node-to-node interconnections between the various layers. In some cases, the network can include a convolutional neural network, which may not link every node in one layer to every other node in the next layer. In networks where information is exchanged between layers, nodes of the input layer 310 can activate a set of nodes in the first hidden layer 320A. For example, as shown, each of the input nodes of the input layer 310 can be connected to each of the nodes of the first hidden layer 320A. The nodes of a hidden layer can transform the information of each input node by applying activation functions (e.g., filters) to this information. The information derived from the transformation can then be passed to and can activate the nodes of the next hidden layer 320B, which can perform their own designated functions. Example functions include convolutional functions, downscaling, upscaling, data transformation, and/or any other suitable functions. The output of the hidden layer 320B can then activate nodes of the next hidden layer, and so on. The output of the last hidden layer 320N can activate one or more nodes of the output layer 340, which provides the processed output data. In some cases, while nodes (e.g., node 360) in the neural network 300 are shown as having multiple output lines, a node has a single output and all lines shown as being output from a node represent the same output value.

Additionally, or alternatively, each node or interconnection between nodes can have a weight that is a set of parameters derived from the training of the neural network 300. For example, an interconnection between nodes can represent a piece of information learned about the interconnected nodes. The interconnection can have a tunable numeric weight that can be tuned (e.g., based on a training dataset), allowing the neural network 300 to be adaptive to inputs and able to learn as more and more data is processed.

The neural network 300 is pre-trained to process the features from the data in the input layer 310 using the different hidden layers 320A, 320B, through 320N in order to provide the output through the output layer 340.

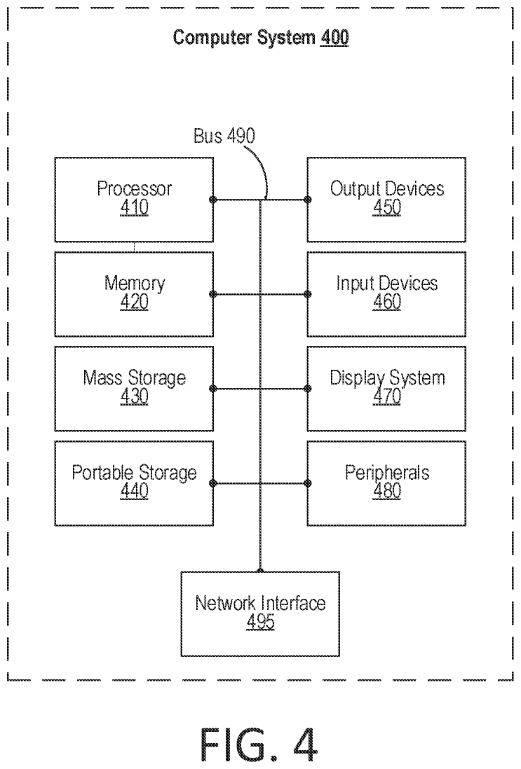

FIG. 4 illustrates an exemplary computing system that may be used to implement methods consistent with the present disclosure. Any of the computing devices, computing systems, network devices, network systems, servers, and/or arrangements of circuitry described herein may include at least one computing system 400, or may include at least one component of the computer system 400 identified in FIG. 4. The computing system 400 of FIG. 4 includes one or more processors 410 and memory 420. Each of the processor(s) 410 may refer to one or more processors, controllers, microcontrollers, central processing units (CPUs), graphics processing units (GPUs), arithmetic logic units (ALUs), accelerated processing units (APUs), digital signal processors (DSPs), application specific integrated circuits (ASICs), field-programmable gate arrays (FPGAs), or combinations thereof. Each of the processor(s) 410 may include one or more cores, either integrated onto a single chip or spread across multiple chips connected or coupled together. Memory 420 stores, in part, instructions and data for execution by processor 410. Memory 420 can store the executable code when in operation. The system 400 of FIG. 4 further includes a mass storage device 430, portable storage medium drive(s) 440, output devices 450, user input devices 460, a graphics display system 470, peripheral device(s) 480, bus 490, and network interface 495.

The components shown in FIG. 4 are depicted as being connected via a single bus 490. However, the components may be connected through one or more data transport means. Processor unit 410 and memory 420 may be connected via a local microprocessor bus 490, and the mass storage device 430, peripheral device(s) 480, portable storage device 440, and display system 470 may be connected via one or more input/output (I/O) buses.

Mass storage device 430, which may be implemented with a magnetic disk drive or an optical disk drive, is a non-volatile storage device for storing data and instructions for use by processor unit 410. Mass storage device 430 can store the system software for implementing some aspects of the subject technology for purposes of loading that software into memory 420.

Portable storage device 440 operates in conjunction with a portable non-volatile storage medium, such as a floppy disk, compact disk or digital video disc, to input and output data and code to and from the computer system 400 of FIG. 4. The system software for implementing aspects of the subject technology may be stored on such a portable medium and input to the computer system 400 via the portable storage device 440.

The memory 420, mass storage device 430, or portable storage 440 may in some cases store sensitive information, such as transaction information, health information, or cryptographic keys, and may in some cases encrypt or decrypt such information with the aid of the processor 410. The memory 420, mass storage device 430, or portable storage 440 may in some cases store, at least in part, instructions, executable code, or other data for execution or processing by the processor 410.

Output devices 450 may include communication circuitry for outputting data through wired or wireless means, display circuitry for displaying data via a display screen, audio circuitry for outputting audio via headphones or a speaker, printer circuitry for printing data via a printer, or some combination thereof. The display screen may be any type of display discussed with respect to the display system 470. The printer may be inkjet, laser jet, thermal, or some combination thereof. In some cases, the output device circuitry 450 may allow for transmission of data over an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, 802.11 Wi-Fi wireless signal transfer, cellular data network wireless signal transfer, a radio wave signal transfer, a microwave signal transfer, an infrared signal transfer, a visible light signal transfer, an ultraviolet signal transfer, a wireless signal transfer along the electromagnetic spectrum, or some combination thereof. Output devices 450 may include any ports, plugs, antennae, wired or wireless transmitters, wired or wireless transceivers, or any other components necessary for or usable to implement the communication types listed above, such as cellular Subscriber Identity Module (SIM) cards.

Input devices 460 may include circuitry providing a portion of a user interface. Input devices 460 may include an alpha-numeric keypad, such as a keyboard, for inputting alpha-numeric and other information, or a pointing device, such as a mouse, a trackball, stylus, or cursor direction keys. Input devices 460 may include touch-sensitive surfaces as well, either integrated with a display as in a touchscreen, or separate from a display as in a trackpad. Touch-sensitive surfaces may in some cases detect localized variable pressure or force detection. In some cases, the input device circuitry may allow for receipt of data over an audio jack, a microphone jack, a universal serial bus (USB) port/plug, an Apple® Lightning® port/plug, an Ethernet port/plug, a fiber optic port/plug, a proprietary wired port/plug, a wired local area network (LAN) port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, 802.11 Wi-Fi wireless signal transfer, wireless local area network (WAN) signal transfer, cellular data network wireless signal transfer, personal area network (PAN) signal transfer, wide area network (WAN) signal transfer, a radio wave signal transfer, a microwave signal transfer, an infrared signal transfer, a visible light signal transfer, an ultraviolet signal transfer, a wireless signal transfer along the electromagnetic spectrum, or some combination thereof. Input devices 460 may include any ports, plugs, antennae, wired or wireless receivers, wired or wireless transceivers, or any other components necessary for or usable to implement the communication types listed above, such as cellular SIM cards.

Input devices 460 may include receivers or transceivers used for positioning of the computing system 400 as well and input devices 460 may be communicatively coupled to one or more sensors, such as vehicle sensors 105 of FIG. 1. These may include any of the wired or wireless signal receivers or transceivers that may receive or send (transmit) data. A location of the computing system 400 can be determined based on signal strength of signals as received at the computing system 400 from three cellular network towers, a process known as cellular triangulation. Fewer than three cellular network towers can also be used—even one can be used—though the location determined from such data will be less precise (e.g., somewhere within a particular circle for one tower, somewhere along a line or within a relatively small area for two towers) than via triangulation. More than three cellular network towers can also be used, further enhancing the location's accuracy. Similar positioning operations can be performed using proximity beacons, which might use short-range wireless signals such as BLUETOOTH® wireless signals, BLUETOOTH® low energy (BLE) wireless signals, IBEACON® wireless signals, personal area network (PAN) signals, microwave signals, radio wave signals, or other signals discussed above. Similar positioning operations can be performed using wired local area networks (LAN) or wireless local area networks (WLAN) where locations are known of one or more network devices in communication with the computing system 400 such as a router, modem, switch, hub, bridge, gateway, or repeater. These may also include Global Navigation Satellite System (GNSS) receivers or transceivers that are used to determine a location of the computing system 400 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. Input devices 460 may include receivers or transceivers corresponding to one or more of these GNSS systems.

Display system 470 may include a liquid crystal display (LCD), a plasma display, an organic light-emitting diode (OLED) display, an electronic ink or “e-paper” display, a projector-based display, a holographic display, or another suitable display device. Display system 470 receives textual and graphical information, and processes the information for output to the display device. The display system 470 may include multiple-touch touchscreen input capabilities, such as capacitive touch detection, resistive touch detection, surface acoustic wave touch detection, or infrared touch detection. Such touchscreen input capabilities may or may not allow for variable pressure or force detection.

Peripherals 480, also referred to as peripheral device(s) 480, may include any type of computer support device to add additional functionality to the computer system. Peripheral device(s) 480 may include one or more additional output devices of any of the types discussed with respect to output device 450, one or more additional input devices of any of the types discussed with respect to input device 460, one or more additional display systems of any of the types discussed with respect to display system 470, one or more memories or mass storage devices or portable storage devices of any of the types discussed with respect to memory 420 or mass storage 430 or portable storage 440, a modem, a router, an antenna, a wired or wireless transceiver, a printer, a bar code scanner, a quick-response (“QR”) code scanner, a magnetic stripe card reader, a integrated circuit chip (ICC) card reader such as a smartcard reader or a EUROPAY®-MASTERCARD®-VISA® (EMV) chip card reader, a near field communication (NFC) reader, a document/image scanner, a visible light camera, a thermal/infrared camera, an ultraviolet-sensitive camera, a night vision camera, a light sensor, a phototransistor, a photoresistor, a thermometer, a thermistor, a battery, a power source, a proximity sensor, a laser rangefinder, a sonar transceiver, a radar transceiver, a lidar transceiver, a network device, a motor, an actuator, a pump, a conveyer belt, a robotic arm, a rotor, a drill, a chemical assay device, or some combination thereof.

Network interface 495 may be used to send data to or receive data from other computing devices. These communications may be sent via communication tower 135 or may be communicated via network 145 of FIG. 1. Network interface 495 may be any computer communication network standard in the art.

The components contained in the computer system 400 of FIG. 4 can include those found in computer systems that may be suitable for use with some aspects of the subject technology and represent a broad category of such computer components. That said, the computer system 400 of FIG. 4 can be customized and specialized for the purposes discussed herein and to carry out the various operations discussed herein, with specialized hardware components, specialized arrangements of hardware components, and/or specialized software. Thus, the computer system 400 of FIG. 4 can be a personal computer, a hand held computing device, a telephone (“smartphone” or otherwise), a mobile computing device, a workstation, a server (on a server rack or otherwise), a minicomputer, a mainframe computer, a tablet computing device, a wearable device (such as a watch, a ring, a pair of glasses, or another type of jewelry or clothing or accessory), a video game console (portable or otherwise), an e-book reader, a media player device (portable or otherwise), a vehicle-based computer, another type of computing device, or some combination thereof. The computer system 400 may in some cases be a virtual computer system executed by another computer system. The computer can also include different bus configurations, networked platforms, multi-processor platforms, etc. Various operating systems can be used including Unix®, Linux®, FreeBSD®, FreeNAS®, pfSense®, Windows®, Apple® Macintosh OS® (“MacOS®”), Palm OS®, Google® Android®, Google® Chrome OS®, Chromium® OS®, OPENOPERATION®, XNU®, Darwin®, Apple® iOS®, Apple® tvOS®, Apple® watchOS®, Apple® audioOS®, Amazon® Fire OS®, Amazon® Kindle OS®, variants of any of these, other suitable operating systems, or combinations thereof. The computer system 400 may also use a Basic Input/Output System (BIOS) or Unified Extensible Firmware Interface (UEFI) as a layer upon which the operating system(s) are run.

In some cases, the computer system 400 may be part of a multi-computer system that uses multiple computer systems 400, each for one or more specific tasks or purposes. The multi-computer system may include multiple computer systems 400 communicatively coupled together via at least one of a personal area network (PAN), a local area network (LAN), a wireless local area network (WLAN), a municipal area network (MAN), a wide area network (WAN), or some combination thereof. The multi-computer system may further include multiple computer systems 400 from different networks communicatively coupled together via the internet (also referred to as a “distributed” system).

Some aspects of the subject technology may be implemented in an application that may be operable using a variety of devices. Non-transitory computer-readable storage media refer to any medium or media that participate in providing instructions to a central processing unit (CPU) for execution and that may be used in the memory 420, the mass storage 430, the portable storage 440, or some combination thereof. Such media can take many forms, including, but not limited to, non-volatile and volatile media such as optical or magnetic disks and dynamic memory, respectively. Some forms of non-transitory computer-readable media include a processor or multiple processors that executes instructions accessed via FLASH memory, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a Blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L4), resistive random-access memory (RRAM/ReRAM), phase change memory (PCM), spin transfer torque RAM (STT-RAM), another memory chip or cartridge, or a combination thereof.

Various forms of transmission media may be involved in carrying one or more sequences of one or more instructions to a processor 410 for execution. A bus 490 carries the data to system RAM or another memory 420, from which a processor 410 retrieves and executes the instructions. The instructions received by system RAM or another memory 420 can optionally be stored on a fixed disk (mass storage device 430/portable storage 440) either before or after execution by processor 410. Various forms of storage may likewise be implemented as well as the necessary network interfaces and network topologies to implement the same.

While various flow diagrams provided and described above may show a particular order of operations performed by some embodiments of the subject technology, it should be understood that such order is exemplary. Alternative embodiments may perform the operations in a different order, combine certain operations, overlap certain operations, or some combination thereof. It should be understood that unless disclosed otherwise, any process illustrated in any flow diagram herein or otherwise illustrated or described herein may be performed by a device, machine, mechanism, computing system 400, and/or computing system 500 discussed herein, and may be performed automatically (e.g., in response to one or more triggers/conditions described herein), autonomously, semi-autonomously (e.g., based on received instructions), or a combination thereof. Furthermore, any action described herein as occurring in response to one or more particular triggers/conditions should be understood to optionally occur automatically response to the one or more particular triggers/conditions.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A method for vehicle operation analysis, the method comprising:
receiving vehicle operation data associated with a plurality of vehicles and a plurality of operators, wherein the vehicle operation data includes telematics sensor information associated with each of the plurality of operators operating one or more respective vehicles of the plurality of vehicles;
receiving incident data associated with a plurality of negative vehicle operation outcomes that each involve a respective vehicle of the plurality of vehicles and a respective operator of the plurality of operators;
using one or more trained machine learning models to identify a riskiest operator of the plurality of operators at least in part by inputting at least the vehicle operation data and the incident data into the one or more trained machine learning models; and
outputting an alert indicating the riskiest operator.

2. The method of claim 1, wherein using the one or more trained machine learning models to identify the riskiest operator includes using the one or more trained machine learning models to rank the plurality of operators by level of risk.

3. The method of claim 1, wherein using the one or more trained machine learning models to identify the riskiest operator includes using the one or more trained machine learning models to identify one or more predicted negative vehicle operation outcomes associated with the riskiest operator.

4. The method of claim 1, further comprising:
identifying contextual attributes associated with a driving schedule;
identifying roadway attributes associated with the driving schedule;
identifying driver attributes associated with the driving schedule; and
comparing the contextual attributes and the roadway attributes with the driver attributes to forecast a potential negative outcome, wherein identifying the riskiest operator is based on comparison of the contextual attributes and the roadway attributes with the driver attributes.

5. The method of claim 4, wherein the contextual attributes include one or more of a speed limit, a level of traffic flow, and a time of day, and wherein the roadway attributes include a roadway type.

6. The method of claim 1, wherein the plurality of negative vehicle operation outcomes includes instances of speeding.

7. The method of claim 1, wherein the plurality of negative vehicle operation outcomes includes instances of harsh braking.

8. The method of claim 1, wherein the plurality of negative vehicle operation outcomes includes instances of swerving.

9. The method of claim 1, further comprising:
receiving feedback regarding the riskiest operator; and
updating the one or more trained machine learning models by using the feedback as additional training data.

10. The method of claim 1, wherein outputting the alert includes displaying the alert using a display.

11. The method of claim 1, wherein outputting the alert includes transmitting the alert to a recipient device.

12. The method of claim 1, wherein outputting the alert includes automatically assigning the riskiest operator to a coaching session.

13. The method of claim 1, wherein the one or more trained machine learning models include one or more random forests.

14. A non-transitory computer-readable storage medium having embodied thereon a program executable by a processor for implementing a method for vehicle operation analysis, the method comprising:
receiving vehicle operation data associated with a plurality of vehicles and a plurality of operators, wherein the vehicle operation data includes telematics sensor information associated with each of the plurality of operators operating one or more respective vehicles of the plurality of vehicles;
receiving incident data associated with a plurality of negative vehicle operation outcomes that each involve a respective vehicle of the plurality of vehicles and a respective operator of the plurality of operators;
using one or more trained machine learning models to identify a riskiest operator of the plurality of operators at least in part by inputting at least the vehicle operation data and the incident data into the one or more trained machine learning models; and
outputting an alert indicating the riskiest operator.

15. The non-transitory computer-readable storage medium of claim 14, wherein using the one or more trained machine learning models to identify the riskiest operator includes using the one or more trained machine learning models to rank the plurality of operators by level of risk.

16. The non-transitory computer-readable storage medium of claim 14, wherein using the one or more trained machine learning models to identify the riskiest operator includes using the one or more trained machine learning models to identify one or more predicted negative vehicle operation outcomes associated with the riskiest operator.

17. The non-transitory computer-readable storage medium of claim 14, wherein the program is further executable to:
identify contextual attributes associated with a driving schedule;
identify roadway attributes associated with the driving schedule;
identify driver attributes associated with the driving schedule; and
compare the contextual attributes and the roadway attributes with the driver attributes to forecast a potential negative outcome, wherein identifying the riskiest operator is based on comparison of the contextual attributes and the roadway attributes with the driver attributes.

18. The non-transitory computer-readable storage medium of claim 14, wherein the plurality of negative vehicle operation outcomes includes instances of speeding.

19. The non-transitory computer-readable storage medium of claim 14, wherein the plurality of negative vehicle operation outcomes includes instances of harsh braking.

20. An apparatus that analyzes operational characteristics of vehicles based on a machine learning model, the apparatus comprising:
a memory; and
a processor that executes instructions of the machine learning model out of the memory to:
evaluate received vehicle operation data associated with a plurality of vehicles and a plurality of operators, wherein the vehicle operation data includes telematics sensor information associated with each of the plurality of operators operating one or more respective vehicles of the plurality of vehicles,
evaluate received incident data associated with a plurality of negative vehicle operation outcomes that each involve a respective vehicle of the plurality of vehicles and a respective operator of the plurality of operators,
identify a riskiest operator of a plurality of operators based on the vehicle operation data and the incident data being inputs of the machine learning model, and
output an alert indicating the riskiest operator.
